(19) United States
(12) Patent Application Publication
(10) Pub. No.: US 2012/0016809 A1
(43) Pub. Date: Jan. 19, 2012

(54) SYSTEMS AND METHODS FOR INVESTOR-DRIVEN CREATIVE PRODUCTION

(76) Inventors: Anton Frolov, Bell Canyon, CA (US); Oksana Frolov, Bell Canyon, CA (US)

(21) Appl. No.: 12/838,249

(22) Filed: Jul. 16, 2010

(51) Int. Cl. G06Q 40/00

(52) U.S. Cl. 705/36 R

(57) ABSTRACT

A system for investor-driven creative production, in one example embodiment, comprises a receiving module to receive metadata associated with the creative production. The metadata can be received from a creative content provider via a creative content interface and include a description of the creative production and an investment goal. The system can further include a posting module to post the metadata to the creative content interface and the receiving module to receive an investment in the creative production from an investor via the creative content interface. The system can further include an investment processing module to determine that the investment goal is reached and a production initiation module to selectively commence the creative production based on the determination that the investment goal is reached.

### FIELD

This application relates generally to data processing, and more specifically, to systems and methods for investor-driven creative production.

### BACKGROUND

Technology has improved productivity and efficiency in nearly every area of human life. Electronic devices now perform many functions previously performed manually. The Internet allows users to participate in remote activities that previously required personal attendance. However, the process of selection of creative content for production remains in the realm of a few experts commissioned by large production companies. Because access to these experts is carefully guarded, unknown content creators have no opportunity to be heard. Accordingly, creative content remains undiscovered despite its possible merits.

### BRIEF DESCRIPTION OF DRAWINGS

Example embodiments are illustrated by way of example and not limitation in the figures of the accompanying drawings, in which like references indicate similar elements, and in which:

FIG. 1 is a block diagram showing a network environment within which systems and methods for investor-driven creative production are implemented, in accordance with an example embodiment;

FIG. 2 is a block diagram showing a creative content production engine, in accordance with an example embodiment;

FIG. 3 is a block diagram showing a creative content interface, in accordance with an example embodiment;

FIG. 4 is a flow chart showing a method for investor-driven creative production, in accordance with an example embodiment; and

FIG. 5 is a diagrammatic representation of an example machine in the form of a computer system within which a set of instructions for causing the machine to perform any one or more of the methodologies discussed herein is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, and structural, logical, and/or electrical changes can be made without departing from the scope of what is claimed. The following detailed description is, therefore, not to be taken in a limiting sense, and the scope is defined by the appended claims and their equivalents.

In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The systems and methods for investor-driven production, in some example embodiments, facilitate production of creative content such as movies, performances, publications, television shows, music albums, and electronic games. A creative content interface having a user interface can be utilized to permit postings of various creative projects in need of investment and/or third party services such as development, production, and distribution. A creative content provider can post a creative project to create an offering to prospective investors and service providers. To describe the project to prospective investors and service providers, each project can be accompanied by a description. For example, an investment offering concerning a movie production can be accompanied by a movie synopsis.

In some example embodiments, each investment offering can be classified according to its type and placed into the appropriate section of the creative content interface. Each type of the creative production can be further grouped according to its genre. In order to appropriately classify the posting, a creative content provider can be asked to provide information relating to the posting.

In some example embodiments, one or more forms can be provided to a creative content provider according to the type of the creative production. For example, one form can be provided to one creative content provider for a project associated with a movie production, while yet another form can be provided to another creative content provider for a project associated with a book publication. Each of the creative production-specific forms can include various fields designed to gather relevant information and to make the process of posting of creative projects uniform.

In some example embodiments, a service provider willing to offer his services for a specific project can be asked to complete an appropriate form designed to gather relevant information. Thus, a specific form can be provided to each prospective service provider, depending on his indicated specialty, such as a playwright, movie producer, or director.

In some example embodiments, an investor can invest in a creative project by using electronic payment means such as a credit card, a debit card, a bank account, or an electronic payment system. In order to make an investment decision with respect to a particular project, an investor can review the description of the project, data pertinent to the one or more individuals associated with the project, and the amount of the current investment in the project.

Thus, the systems and methods for investor-driven production can allow a creative content provider to bypass conventional experts associated with large production companies. Additionally, the systems and methods for investor-driven production can allow an investor to invest directly in a creative production project. Moreover, an interested party can become an investor as well as a source of advertisement of the resulting creative production (such as a music album, a book, a movie, a live performance, and/or video game). An investor buying shares of a production company expresses his trust in the ability of a creative provider and/or a team of individuals behind the production to create valuable content. Furthermore, the investors, as a group, can provide a broad audience to a creative content provider, who otherwise would not be able to produce the creative content.

For example, a method for investor-driven production can commence with a creative content provider, who has an idea for a movie, posting a movie synopsis in the movie section of the creative content interface. Upon review of the synopsis, a service provider such as a playwright or a movie director, or both, can express interest in the movie. Other professionals can also decide to join the project upon reviewing the synopsis. In some example embodiments, before investors are allowed to invest in the project, an initial vote by a specific group of persons can be conducted. The vote may or may not involve funds. For example, before the general public is allowed to invest in a project via the creative content interface, an initial investment can be raised through a private investment club. This initial investment can be utilized to cover expenses associated with the initial effort to develop a movie, book, television program, live performance, music album, or video game.

Once the project is posted and open for investment, prospective investors can read the synopsis of the project. For example, an author may wish to publish a book but lacks sufficient funds to accomplish his objective. The author can post a description of the book and a business plan for the publication on the creative content interface. One or more individual investors may then be able to invest as much as they want. For example, if the project investment goal is $20,000, the investor can offer $20,000 to buy 100% of the shares in the project, which may translate into the full rights to the published book.

In some example embodiments, the creative content provider can specify that the book publication will be financed with the investment money and the return on the investment will be provided according to the specific terms of the investment agreement. In some example embodiments, tangible rewards related to the project can be promised to the investors. For example, an investor who invests at least $20 can be promised to receive a copy of the book when it is published. The investment process can be open to outside observers, and in addition, each user visiting the creative content interface can view how the project investment fund is taking shape. Thus, besides providing the investment funds, the investors can provide viral advertisement for the project.

In some example embodiments, a project team can be formed once the investment goal is reached. The team can report the progress of the project, its milestones, and its results to a designated project coordinator and/or the investors. In some example embodiments, a plurality of projects can be combined to allow investment in a plurality of projects to diversify investment risks.

A project may never achieve its investment goal and in such a case, the money invested in the project can be returned to the investors. Thus, if the interest in a project is such that not enough investment is generated, the project can be cancelled. On the other hand, if, for example, insufficient shares are purchased and the project lacks the funds to proceed, the investors can be asked to increase their investment to keep the project from being cancelled. In some example embodiments, investors can be allowed to roll their investment in a cancelled project into a different project.

Thus, the systems and methods for investor-driven production can effectively facilitate a social network which includes creative content providers, actors, writers, playwrights, directors, and producers. These independent professionals may have difficulties in bringing their projects to life because of the bureaucracy inherent in the conventional process of selecting creative content. Not only is the conventional process highly subjective, but it also lacks sufficient resources to evaluate all submitted creative content.

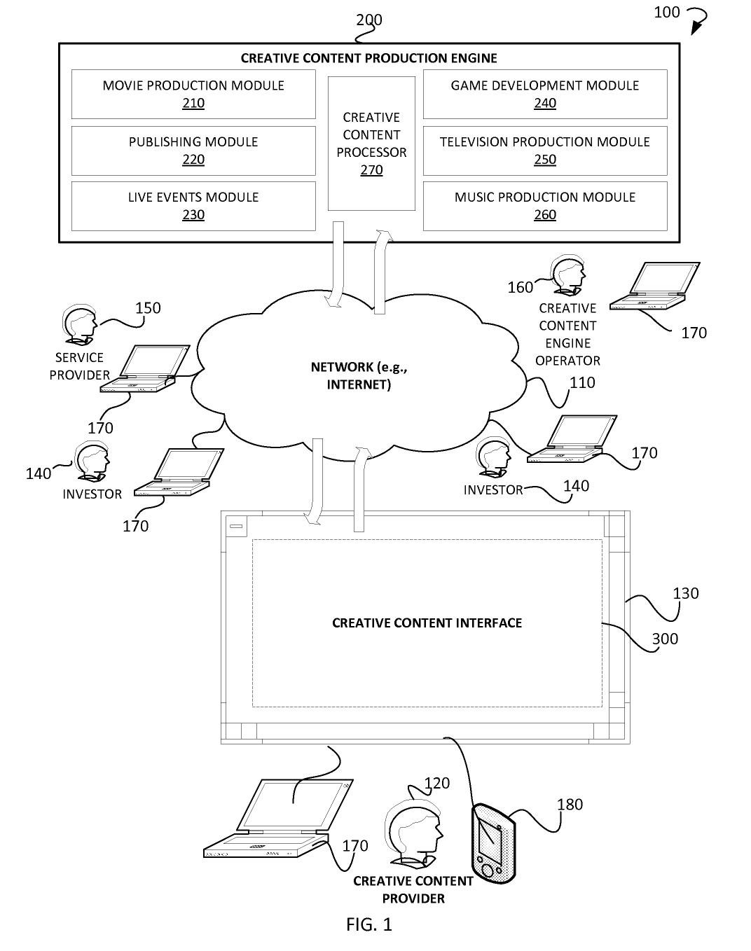

FIG. 1 is a block diagram showing network environment 100 within which systems and methods for investor-driven creative production can be implemented, in accordance with an example embodiment. As shown in FIG. 1, the network environment 100 may include a computer network 110, a creative content provider 120, an Internet browser 130, an investor 140, a service provider 150, a creative content engine operator 160, computers 170, a mobile device 180, and a creative content production engine 200.

The network 110, in some example embodiments, is a network of data processing nodes, which are interconnected for the purpose of data communication (e.g., a global computer network, such as the Internet). The creative content provider 120 is a person or organization that can create and post creative content. The creative content can include novels, epics, short stories, and poems.

The Internet browser 130 is a software application for retrieving, presenting, and traversing information resources on the World Wide Web. An information resource is identified by a Uniform Resource Identifier (URI) and may be a web page, image, video, or other piece of content. Hyperlinks present in the resources enable users to navigate the browser 130 to related resources.

The investor 140 is any party that makes an investment in a creative project using the network 110. The investor 140 can be an individual, a group of individuals, or an institution. The service provider 150, in some example embodiments, is a member of a team formed for a creative production. A movie director is an example of a service provider for a movie production. The creative content engine operator 160 is an individual or an organization operating the creative content production engine 200. Computers 170 are various programmable machines that receive input, store and manipulate data, and provide output in a useful format.

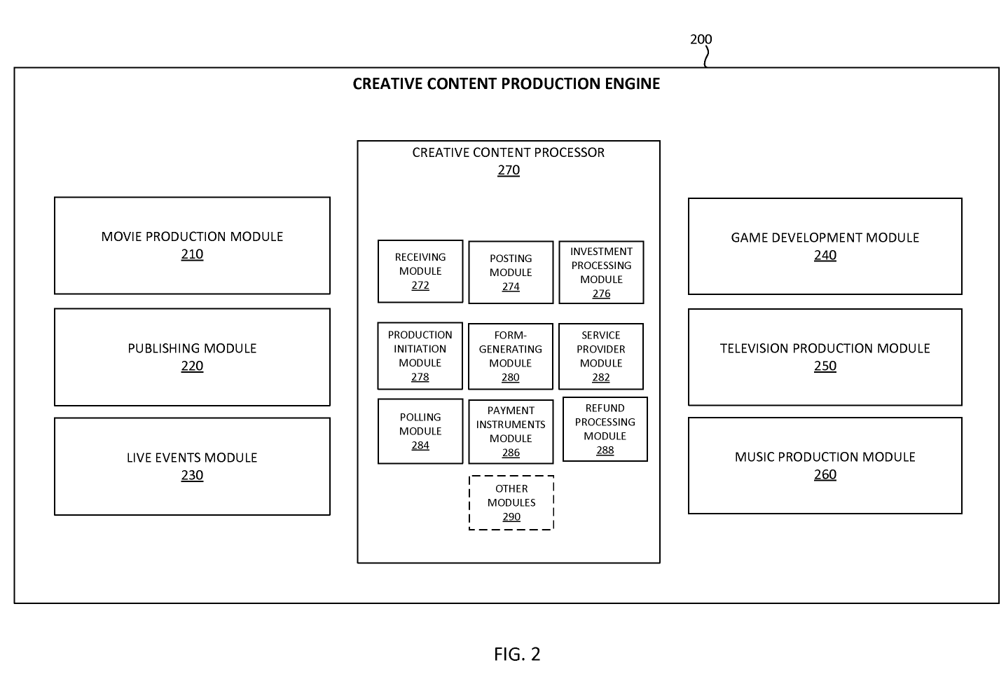

A mobile device 180 (also known as a cell phone device, handheld device, handheld computer, or simply “handheld”) is a pocket-sized computing device, typically having a display screen with touch input or a miniature keyboard. In the case of the personal digital assistant (PDA), the input and output are combined into a touch-screen interface. Smartphones and PDAs are popular amongst those who require the assistance and convenience of a conventional computer, in environments where carrying one would not be practical. The creative content production engine 200 is described by way of example with reference to FIG. 2.

FIG. 2 is a block diagram showing a creative content production engine 200, in accordance with an example embodiment. The creative content production engine 200 may comprise the movie production module 210, the publishing module 220, the live events module 230, the game development module 240, the television production module 250, the music production module 260, and the creative content processor 270.

The movie production module 210, in some example embodiments can facilitate production of movies from an initial story idea or commission through scriptwriting, shooting, editing, directing and, finally, to distribution to an audience. A movie production can involve a large number of people and can take from a few months to several years to complete.

A movie production may commence with development of a script which is written and drafted into a workable blueprint for a movie. The script can be followed by a pre-production where preparations are made for the shoot, cast and crew are hired, locations are selected, and sets are built. In the production stage, the raw elements for the finished movie can be recorded. In the post-production stage the movie is edited, production sound is edited, music tracks are recorded, and computer-graphic visual effects are added. In the sales and distribution stage, the movie can be screened for potential buyers or distributors, picked up by a distributor, and reach its movie theatre or home media audience.

In the development stage, the project's producer seeks a suitable story. According to an example method for investor-driven creative production, an investor can participate in selecting a story for production of a movie by investing in the project. The story may not necessarily be an original one. Instead, the story may be an adaptation of an existing book, play, or another movie. In some example embodiments, an investor may have an option of purchasing rights to the adaptation.

For purposes of this disclosure, a movie producer can be someone who creates the scenes and conditions for making movies and also initiates, coordinates, supervises, and controls matters such as fund-raising, hiring key personnel and arranging for distributors. The producer can be involved throughout the movie-making process from development to completion of a project.

After identifying a theme or an underlying message, the producer may work with a writer to prepare a synopsis. The synopsis may accompany the project posting on the creative content interface and help the investors decide whether the movie will be produced. In some example embodiments, once the final investment goal is reached, a step outline can be created. The step outline may break the story down into one-paragraph scenes that concentrate on dramatic structure.

In some example embodiments, the step outline can be created once an intermediary investment goal is reached so that a treatment of the story can be financed. The treatment can be prepared along with the mood and characters of the story. The treatment may include some dialog and stage direction and may contain drawings to enable the viewer to visualize key points. Next, a screenwriter can write the screenplay. In some example embodiments, investors can vote to select the screenwriter. However, the producer may be given the authority to override the results of the vote by the investors and select the screenwriter himself.

For example, in a flexible budget situation, there may be multiple pending offers from various screenwriters to write the screenplay for their respective pay rates. The choice of the screenwriter may depend on the amount already invested or on the intermediary investment goal. In some example embodiments, a screenwriter can be selected prior to reaching the investment goal. Once the fixed intermediary goal is reached, the project can transition into the second stage. In the second stage, the investors are able to invest amounts corresponding to their share of investment in the first stage or increase their share in the project.

Over a period of time, the screenwriter may rewrite the script several times in order to improve dramatization, clarity, structure, characters, dialogue, and/or overall style. In some example embodiments, the producer may develop various submitted screenplays, and the investors, as well as other users, can review the screenplay online. Additionally, a service provider interested in providing services for the project can also review the script.

In some example embodiments, a movie distributor can be contacted at the second stage of the production to assess the market and the likelihood of financial success of the movie. In some example embodiments, the potential success can be estimated automatically prior to commencement of the project by taking into account different factors, such as the movie genre, the target audience, the historical success of similar movies, the actors appearing in the movie, and the director. In some example embodiments, these factors can be analyzed in the second stage of the production. The investment goal may depend on these factors. For example, when a popular actor commits to the movie production, the budget may be increased to take into account higher anticipated expenses and the increased investment in the production. In some example embodiments, investors may be able to select from a plurality of actors for a movie role.

The creative content processor 270 can facilitate production and can include a receiving module 272, a posting module 274, an investment processing module 276, a production initiation module 278, a form generating module 280, a service-provider module 282, a polling module 284, a payment instruments module 286, a refund processing module 288, and other modules 290.

The production initiation module 278 can selectively commence the creative production based on the determination that the investment goal is reached. The form-generating module 280 can generate a form associated with the creative content interface 300 shown in FIG. 1, with the form facilitating receipt of the metadata from the creative content provider 120. The metadata can include services being sought in connection with the creative production.

The service provider module 282 can process an offer from the service provider 150 to participate in the creative production. The polling module 284 can receive, from the service provider 150, an opinion regarding the creative production. The payment instruments module 286 can be facilitated by one or more of the following electronic payment tools: a credit card, a bank account, or an electronic payment system. The refund processing module 288 can be utilized to refund the investment to the investor if the investment goal is not reached. The other modules 290 can represent other modules which facilitate the production process.

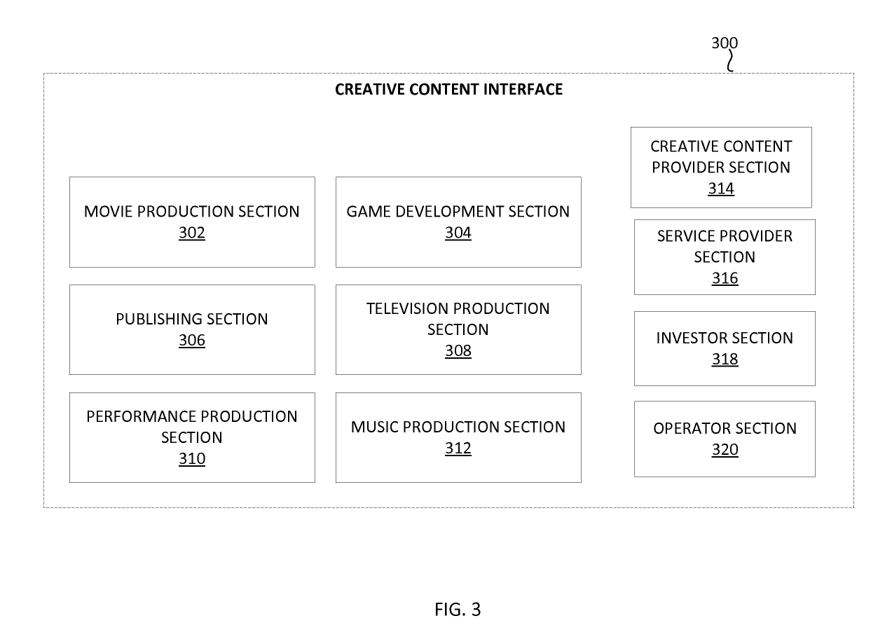

In some example embodiments, the service provider 150 may utilize a service provider section 316, illustrated in FIG. 3 of the drawings, to provide candidacy at a certain rate, thereby providing users with a choice. The investors 140 can participate in the selection of the service provider 150. However, the investors 140 can be warned that their vote can be overridden by the producer. In some example embodiments, selection of the service provider 150 can be outsourced to a third party. For example, an agent can be hired to select the service provider 150. The agent can have access to the breakdown services which allow performing a broader search, sometimes on a national level. These services may not be available to the general public.

Instead of trying to guess which factors will appeal to the potential audience, the methods for investor-driven production can permit the potential audience to participate in the process by investing in the production. A producer and a screenwriter can prepare the treatment (a movie pitch) and present it to potential investors on the creative content interface 300. If the treatment is successful, the movie receives a “green light” from the investors 140 by reaching the investment goal. Thus, instead of having a major movie studio, movie council, or independent investor to finance the movie production, the financial backing comes from the investors 140.

As mentioned above, a system for investor-driven production can facilitate securing finances based on the synopsis of the movie even before a screenplay is written. Once the second intermediary investment goal is reached, the project can transition into the pre-production period. By that time the producer may have a clearly defined marketing strategy and target audience.

In the pre-production stage, the movie can be designed and planned. A production company can be created and the production office established. The expenses associated with the establishment of the production office can be covered by the second stage investment. At this point, the production can be storyboarded and visualized with the help of illustrators and concept artists. A production budget can be drawn up to plan expenditures for the movie. After the project is initially presented by a team comprising a writer, director, producer, and actor(s), the treatment, coverage, and synopsis can be posted for the prospective investors to view. At this point, the project can sign on a producer who will be responsible for presenting the first draft of a budget. The budget can detail every expense from start to finish. The budget can help those involved to understand how much money needs to be raised from investors and whether the project is feasible.

Thereafter, the producer can hire a crew. The nature of the movie and the budget can determine the size and type of the crew used during moviemaking. In some example embodiments, the initial budget can account for “reasonable” overages such as those brought about, for example, from delays in shooting, shooting additional scenes, or from other miscellaneous expenses. However, in case of an unforeseeable overage, the production can go back to the investment mode in order to raise additional money from the investors.

While many Hollywood blockbusters employ a large cast and crew, a crew of only a few people can make a low-budget, independent movie. Such crew positions may include a director who is primarily responsible for the storytelling, creative decisions, and actor advisor tasks for the movie. The crew positions may also include an assistant director who may manage the shooting schedule and logistics of the production, among other tasks. There may be several types of assistant directors, each with different responsibilities.

A casting director is charged with finding actors to fill the parts in the script. The casting director may decide who is to be cast in the movie before an example method transitions into the second stage. The casting director can also manage auditions if auditions are to be performed. Lead actors can be chosen, often based on the actor's reputation or “star power.”

A location manager is charged with finding and managing movie locations. While most movies are shot in the controllable environment of a studio sound stage, occasionally outdoor sequences can call for filming on location. A production manager can manage the production budget and the production schedule. In some example embodiments, a production manager can be selected beforehand. The production manager can also report progress, on behalf of the production office, to the investors. Thereafter, the movie can be previewed by the investors who typically will constitute the target audience, and any feedback may result in further shooting or edits to the movie.

In the distribution stage, the movie can be released to movie theatres or directly to Digital Video Disc DVD and Blu-ray. Additionally, the movie can be directly downloaded over the Internet. The movie can be duplicated for distribution to movie theaters. Press kits, posters, and other advertising materials can be published so the movie is optimally promoted. Associated expenses can be included in the budget with the production company responsible for the appropriate budgeting. The movie company can release the movie with a launch party, and with press releases, interviews with the press, press preview screenings, and movie festival screenings. A website for the movie can also be created. The movie can be played at selected theatres and the DVD can be released some time later. The distribution rights for the movie and DVD can be sold for worldwide distribution. In some example embodiments, the distributor and the production company can share profits.

Typically, when less than half of a movie's financing comes from a major studio, the movie is considered independent. Thus, a movie produced according to a method for investor-driven creative production may be classified as an independent movie.

Similarly, systems and methods for investor-driven creative production can be utilized to produce a music album or a concert, or to finance a performance by an entertainer in a particular location. If the project is successfully budgeted, the investors may be rewarded with discounted tickets or a percentage of the income received by the production. In some example embodiments, a booking agent can be used to get commitments from actors with the arrangements conditional on budgeting. Free-lance promoters can be hired. A booking agent and a free-lance promoter can produce a concert by locating a venue, providing a sound system and assembling a staff. Producing a show at a location that is rented out for a single evening is typically called “four-walling,” as it entails renting a venue and receiving no additional services or technical equipment other than the space itself. Multiple locations can be offered, to be selected by the investors.

An investor can commit funds by buying securities of the underlying production company. Each project can be structured as a separate production company. The investors can be awarded with discounted tickets to the show being produced. There can be a one-time payout and/or an option to reinvest in a new production. In the event of publication, the investors may receive continuing royalty payments.

It will be noted that even though systems and methods for investor-driven creative production facilitate setting up one or more production companies, such systems and methods are especially useful in providing a market for creative production without generating excessive risk with respect to any one specific production.

An investment, for the purpose of this disclosure, refers to buying and holding shares of stock in one or more creative productions. A movie production can be classified as private (unlisted) company. The investment, for the purposes of this disclosure, can also refer to funding of an infant production company and is similar to venture capital investing, which is generally understood to be higher risk than investment in listed going-concern enterprises. Similarly, systems and methods for investor-driven creative production can be utilized in publishing. Traditionally, publishing refers to the distribution of printed works such as books (the “book trade”) and newspapers. For the purposes of this disclosure, creative writing includes but is not limited to, a novel, an epic, a short story, and a poem.

With the advent of digital information systems and the Internet, the scope of publishing has expanded to include electronic resources, such as the electronic versions of books and periodicals, as well as micropublishing, websites, blogs, video games and the like. However, in order publish on the Internet, the author needs to come up with funds. Systems and methods for investor-driven creative production can be utilized to finance writing a publication and to facilitate payment to the author once the book is written. In some example embodiments, the author can be paid a fixed predetermined amount, receive a percentage of the revenue generated by the publication, and/or be awarded shares of the creative content production.

Publishing can also entail various stages of development. Similar to the movie production embodiments described above, systems and methods for investor-driven creative production, in some example embodiments, can facilitate financing of the publication process for established authors by providing potential investors with a synopsis of the publication. Unknown authors (as defined according to predetermined criteria), however, may need to submit a finished manuscript in order to be considered. An editor or reader may be hired to screen the project and the author may have to bear the initial costs. Once the project receives the “green light,” the costs can be reimbursed out of the publishing budget.

In some example embodiments, manuscripts will be reviewed and rated by one or more selected readers, and such ratings can be published together with the synopsis. These readers can be selected through a provider selection process and be remunerated with either money or shares of the publication. Then, the investors can base their investment decisions on the synopsis, the ratings, and the reviewer's credentials. Established authors can be represented by literary agents who market their respective works and negotiate contracts. In some example embodiments, once the work is accepted by the production company, the purchase of intellectual property rights can be negotiated and the agreement on royalties reached.

In some example embodiments, the author can be compensated with shares of stock in publication, upfront payment coming from the initial funding, or when the investment goal is reached. Publications can include electronic publications distributed on Compact Disc (CD), DVD, Blu-Ray, or other physical media. Electronic publications are not treated differently from a paper format, and a national copyright can be an acceptable approach. However, the possibility of Internet download without the ability to restrict physical distribution within national boundaries can present legal problems that can be completely or partially solved by selling language or translation rights rather than national rights. In this respect, for example, Internet access across the European Union is relatively open because of laws forbidding discrimination based on nationality, but in practice, a publication in French, for example, may be limited to those who reside in France. Therefore, a right to the publication in the French language may be effectively a right to publish in France.

Having agreed on the scope of the publication and the formats, the parties in a book agreement can agree on royalty rates, the percentage of the gross retail price that will be paid to the author, and the advance payment. This can be a difficult exercise because the publisher must estimate the potential sales in each market and balance projected revenue against production costs. Royalties can be set as a certain percentage of the recommended retail price. An advance can be set as a specific fraction of first print run total royalties.

For example, if a book has a print run of 5,000 copies, will be sold at $14.95, and the author receives 10% royalties, the total sum payable to the author if all copies are sold is $7475 (10%×$14.95×5000). The advance in this instance would be roughly $2490. Advances can vary between books, with established authors commanding larger advances.

Once the immediate commercial issues are decided and the technical legal issues resolved, the author may be asked to improve the quality of the work through rewriting or smaller changes, and one or more providers may edit the work. By editing the publication, the production company may maintain a house style, and the providers can copy edit to ensure that the work matches the style and grammatical requirements of each market. The editing may also involve structural changes and requests for more information. Fact checkers may be employed for non-fiction works.

The sales and marketing stage may be closely intertwined with the editorial process. As front cover images are produced or chapters are edited, sales people may advertise the book to the potential investors to build early interest and/or ask the investors to start talking about the publication. Advanced information sheets may be sent to investors or overseas publishers to gauge possible sales. As early interest is measured, this information may feed back through the editorial process and may affect the format of the book and the strategy employed to sell it. For example, if interest from foreign publishers is high, co-publishing deals may be established whereby publishers share printing costs in producing large print runs, thereby lowering the per-unit cost of the books.

On-demand printing can be utilized so that there is no need to undertake a single large-scale release. The number of books issued could be changed daily as interest from readers builds and feedback is given to the publisher. Using this approach, a book can be printed upon receipt of the order, thereby ensuring low costs for storage.

In some example embodiments, potential investors and/or providers can be proactively asked to think of ideas for creative publications which can be posted on the portal. By reacting to book proposals or manuscripts, authors can be encouraged to post synopses of their manuscripts to be voted upon. Once the manuscripts are voted upon, those that get the most votes will be promoted for investment. Additionally, by formulating ideas in dialogue with authors, providers who are commissioning editors can engage in collaboration with the authors. Moreover, readers can commit funds to indicate which books they would like to have published. If the investment goal is reached, the book is published.

In some example embodiments, a production company can be the issuer of the security. The securities can be offered as stock of a particular production company or as stock of a plurality of creative productions. The equity in a production company can be offered as a share of equity interest in an entity such as the capital stock of a creative production company.

Similarly, systems and methods for investor-driven creative production can be utilized to facilitate a live concert tour or a special event performance in which multiple providers can put up a single performance or a complete itinerary, with the users bidding on particular events. The process can help to determine which cities would be a better fit and to ensure minimum attendance. If not enough people buy tickets at the discounted price, the money can be refunded to the investors. Particular artists can request their performance dates, and one or more conditional offers of employment to a particular artist can be made, with one of the conditions being reaching the investment goal. The offer can be made directly to an artist or to the artist's agent or music manager.

In some example embodiments, the promoter and agent can place an advertisement and negotiate the live performance contract. Once the investment goal is reached, the provider who is the tour promoter can do the following (1) obtain a venue such as a concert hall, entertainment center, theater, nightclub or arena for bookings, (2) establish pricing for the event or tour (the pricing for investors can be fixed), and (3) provide air, sea or land transportation (optional). It is expected that the promoter will have upfront funds that can be provided by the investments and/or sponsorship financing to pay for advertising the artists' tours. Such advertising costs, usually referred to as a media or promotional kit, commonly include television and radio advertisements, posters, newspaper and magazine advertisements, and online marketing ads.

Preferably, there will be a detailed budget and an estimate of the cost of each project before the project is presented to investors. Investors can view the detailed budget in order to see where their money is going. The budget can include everything from production to advertisement and will be approved prior to making it available to investors.

Similarly, systems and methods for investor-driven creative production can be utilized to facilitate video game development. Video development is typically undertaken by a game developer, who may be a single person or a large business, and is funded by a publisher. Every year, new independent development companies commence operations and some manage to produce hit titles. However, many developers close down because they cannot find a publishing contract and therefore cannot generate any revenue to sustain them. Systems and methods for investor-driven creative production can permit a game designer to post an initial game proposal document which may include the concept, gameplay, feature list, setting and story, target audience, requirements and schedule, staff and budget estimates.

A video game production can use similar distribution methods to those of the music and movie industries, with some games being distributed to the investors. Systems and methods for investor-driven creative production can be utilized to obtain financing for video games that are already developed and to develop new games. However, because a video game typically takes a long time to produce, the system may be more beneficial to already-developed games.

FIG. 3 is a block diagram showing the creative content interface 300, in accordance with an example embodiment. The creative content interface 300 can comprise a movie production section 302, a game development section 304, a publishing section 306, a television production section 308, a performance production section 310, a music production section 312, a creative content provider section 314, a service provider section 316, an investor section 318, and an operator section 320.

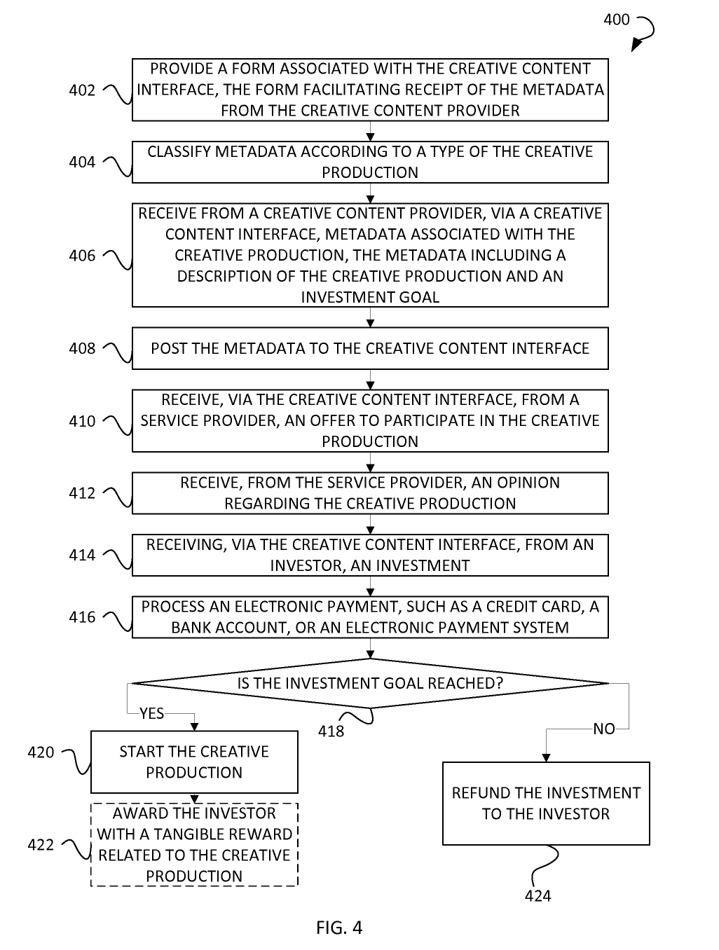

FIG. 4 is a flow chart showing a method for investor-driven creative production 400, in accordance with an example embodiment. The creative production can be a movie, live performance, publication, television show, music production, or electronic game. The method 400 may commence at operation 402 with the form-generating module 280 providing a form associated with creative content interface 300 to facilitate receipt of the metadata from the creative content provider 120. The metadata can be associated with the creative production and can include a description of the creative production and an investment goal. The metadata can further include personal data related to one or more individuals associated with the creative production and a current amount of investment in the creative production. At operation 404, the metadata be classified according to a type of the creative production.

At operation 406, the receiving module 272 can receive the metadata from the creative content provider 120, via the creative content interface 300, and classify the metadata according to a type of the creative production.

At operation 408, the posting module 274 can post the metadata to the creative content interface 300. At operation 410, the receiving module 272 can receive from the service provider 150, via the creative content interface 300, an offer to participate in the creative production. At operation 412, the polling module 284 can receive an opinion regarding the creative production from the service provider 150. At operation 414, the investment processing module 276 can receive, via the creative content interface 300, an investment from one or more investors 140.

At operation 416, the payment instruments module 286 can process an electronic payment, such as a credit card, a bank account, or an electronic payment system. At decision block 418, it can be determined by the investment processing module 276 whether or not the investment goal is reached. If it is determined that the investment goal is not reached, the refund processing module 288 can refund the investment to the investors 140 at operation 424. If, on the other hand, it is determined that the investment goal is reached, the method 400 can proceed to operation 420 where the production initiating module 278 can start the production process. Upon completion of the production, the investors 140 may be awarded with tangible rewards related to the creative production.

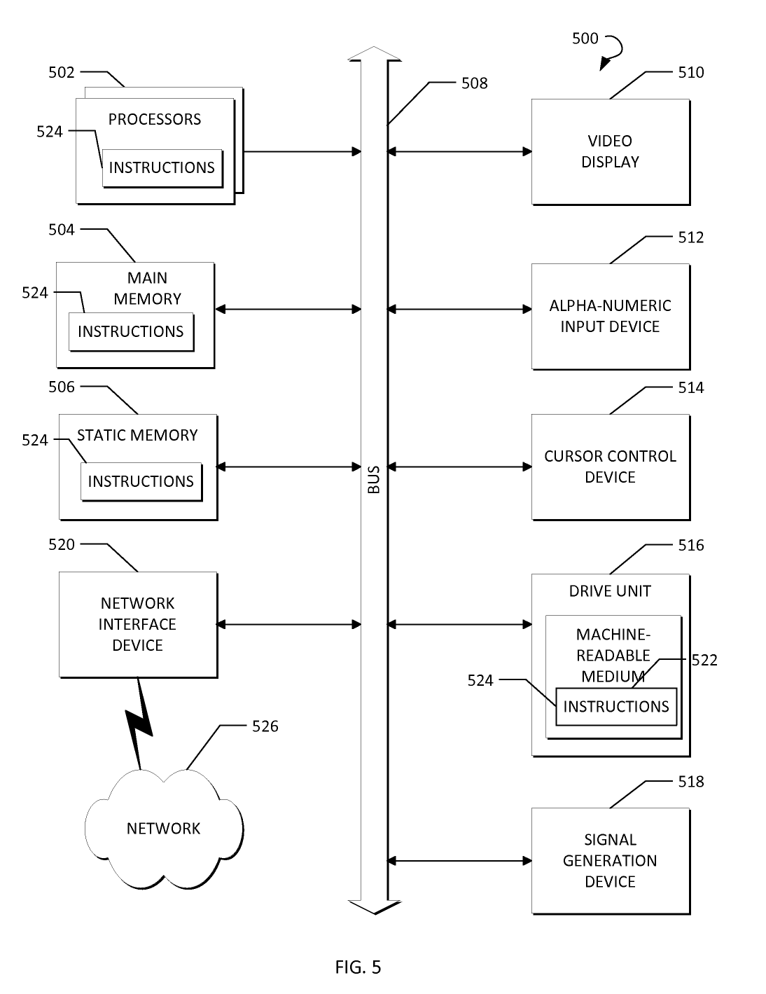

FIG. 5 is a diagrammatic representation of an example machine in the form of a computer system 500, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a PDA, a cellular telephone, a portable music player (e.g., a portable hard drive audio device, such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor or multiple processors 502 (e.g., a central processing unit (CPU), a graphics processing unit (GPU), or both), and a main memory 504 and static memory 506, which communicate with each other via a bus 508. The computer system 500 may further include a video display unit 510 (e.g., a liquid crystals display (LCD) or a cathode ray tube (CRT)). The computer system 500 may also include an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a computer-readable medium 522 on which is stored one or more sets of instructions and data structures (e.g., instructions 524) embodying or utilized by any one or more of the methodologies or functions described herein. The instructions 524 may also reside, completely or at least partially, within the main memory 501 and/or within the processors 502 during execution thereof by the computer system 500. The main memory 501 and the processors 502 may also constitute machine-readable media.

The instructions 524 may further be transmitted or received over a network 526 via the network interface device 520 utilizing any one of a number of well-known transfer protocols (e.g., Hyper Text Transfer Protocol (HTTP)).

While the computer-readable medium 522 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

What we claim is:

1. A computer-implemented method for investor-driven creative production, the method comprising:
receiving from a creative content provider, via a creative content interface, metadata associated with the creative production, the metadata including a description of the creative production and an investment goal;
posting the metadata to the creative content interface;
receiving, via the creative content interface, from an investor, an investment;
determining that the investment goal is reached; and
based on the determination, selectively commencing the creative production.

2. The computer-implemented method of claim 1, further comprising providing a form associated with the creative content interface, the form facilitating receipt of the metadata from the creative content provider.

3. The computer-implemented method of claim 1, wherein the metadata includes one or more of the following: personal data related to one or more individuals associated with the creative production and a current amount of investment in the creative production.

4. The computer-implemented method of claim 1, wherein the creative production is selected from one or more of the following types: a movie, a live performance, a publication, a television show, a music production, and an electronic game.

5. The computer-implemented method of claim 1, further comprising receiving, via the creative content interface, from a service provider, an offer to participate in the creative production.

6. The computer-implemented method of claim 5, further comprising receiving, from the service provider, an opinion regarding the creative production.

7. The computer-implemented method of claim 1, wherein the metadata includes services being sought in connection with the creative production.

8. The computer-implemented method of claim 1, wherein the metadata is classified according to a type of the creative production.

9. The computer-implemented method of claim 1, wherein the investment in the creative production is facilitated by one or more of the following electronic payment tools: a credit card, a bank account, and an electronic payment system.

10. The computer-implemented method of claim 1, wherein the investor is awarded for the investment with a tangible reward related to the creative production.

11. The computer-implemented method of claim 1, further comprising determining that the investment goal is not reached, and based on the determination, refunding the investment to the investor.

12. A system for investor-driven creative production, the system comprising:
a receiving module to receive from a creative content provider, via a creative content interface, metadata associated with the creative production, the metadata including a description of the creative production and an investment goal;
a posting module to post the metadata to the creative content interface;
and the receiving module to further receive, via the creative content interface, from an investor, an investment in the creative production;
an investment processing module to determine that the investment goal is reached; and
a production initiation module to selectively commence the creative production based on the determination that the investment goal is reached.

13. The system of claim 12, further comprising a form-generating module to generate a form associated with the creative content interface, the form facilitating receipt of the metadata from the creative content provider.

14. The system of claim 12, further comprising a service provider module to process an offer from a service provider to participate in the creative production.

15. The system of claim 14, further comprising a polling module to receive, from the service provider, an opinion regarding the creative production.

16. The system of claim 12, wherein the metadata is to include services being sought in connection with the creative production.

17. The system of claim 12, wherein the investment in the creative production is to be facilitated by one or more of the following electronic payment tools: a credit card, a bank account, and an electronic payment system.

18. The system of claim 12, wherein the investor is to be awarded for the investment with a tangible reward related to the creative production.

19. The system of claim 12, wherein the investment processing module is to determine that the investment goal is not reached, and a refund processing module is to refund the investment to the investor when the investment goal is not reached.

20. A machine-readable medium comprising instructions, which when implemented by one or more processors, perform the following operations:
receive from a creative content provider, via a creative content interface, metadata associated with a creative production, the metadata including a description of the creative production and an investment goal;
post the metadata to the creative content interface;
receive, via the creative content interface, from an investor, an investment;
determine that the investment goal is reached; and
based on the determination, selectively commence the creative production.
